(19) United States
(12) Patent Application Publication
(10) Pub. No.: US 2008/0026900 A1
(43) Pub. Date: Jan. 31, 2008

(54) Differential gear

(75) Inventors: Masaki Gotoh, Tochigi-shi (JP); Noboru Higano, Tochigi-ken (JP); Manabu Endou, Tochigi-ken (JP)

Correspondence Address: JORDAN AND HAMBURG LLP, 122 EAST 42ND STREET, SUITE 4000, NEW YORK, NY, 10168, US

(73) Assignee: GKN Driveline Torque Technology KK, Tochigi-ken (JP)

(21) Appl. No.: 11/881,640

(22) Filed: Jul. 26, 2007

(30) Foreign Application Priority Data
Jul. 27, 2006 (JP) 2006-205007

(51) Int. Cl. F16H 48/00; F16D 21/00

(52) U.S. Cl. 475/220; 192/48.1

(57) ABSTRACT

A differential gear includes first and second differential mechanisms that are compact in radial and axial directions, the first and second differential mechanisms 5 and 7 arranged side by side along an axis of rotation in a center casing 3 that is rotatably supported, the differential gear 1 configured to form one of first and second coupling configurations, the first coupling configuration that couples the center casing and first and second differential mechanisms in such a way as to transmit rotation of the center casing to the first and second differential mechanisms in parallel, the second coupling configuration that couples the center casing and first and second differential mechanisms in such a way as to transmit rotation of the center casing to one of the first and second differential mechanisms (e.g. a front casing 31) via the other thereof (e.g. a second output gear 61), and at least one of the first and second differential mechanisms including face gears.

### BACKGROUND OF THE INVENTION

1. Field of the Invention

The present invention relates to a differential gear used for, for example, a vehicle.

2. Description of Related Art

An example of a differential gear used for a four-wheel-drive vehicle is disclosed in Japanese Unexamined Patent Application Publication No. 2002-349669. This differential gear includes a first differential mechanism with bevel gears and a second differential mechanism arranged on the peripheral side of the first differential mechanism.

This differential gear is installed on, for example, the front side of a four-wheel-drive vehicle with the first differential mechanism serving as a front differential and the second differential mechanism as a center differential.

The second differential mechanism is arranged on the peripheral side of the first differential mechanism, and therefore, increases the outer diameter of the differential gear as a whole. This is disadvantageous in securing a minimum ground clearance for the vehicle.

There is another related art that arranges first and second differential mechanisms side by side in a differential gear along an axis of rotation.

This related art increases the axial size of the differential gear, to shorten a distance between constant-velocity joints on an axle, increase a mounting angle of the axle, and deteriorate a noise/vibration control ability.

### SUMMARY OF THE INVENTION

An object of the present invention is to provide a differential gear having first and second differential mechanisms that are compact in radial and axial directions.

In order to accomplish the object, an aspect of the present invention provides a differential gear having an external rotary member configured to rotate; first and second differential mechanisms arranged side by side along an axis of rotation in the external rotary member, the external rotary member and first and second differential mechanisms taking one of first and second coupling configurations, the first coupling configuration coupling the external rotary member and first and second differential mechanisms in such a way as to transmit rotation of the external rotary member to the first and second differential mechanisms in parallel, the second coupling configuration coupling the external rotary member and first and second differential mechanisms in such a way as to transmit rotation of the external rotary member to one of the first and second differential mechanisms via the other of the first and second differential mechanisms; and face gears included in at least one of the first and second differential mechanisms.

With this arrangement, according to the aspect, the differential gear with the first and second differential mechanisms is compact in radial and axial directions.

### BRIEF DESCRIPTION OF THE DRAWINGS

FIG. 1 is a sectional view showing a differential gear according to a first embodiment of the present invention;

FIG. 2 is a side view seen from an arrow A shown in FIG. 1;

FIG. 3 is a side view showing a pinion shaft in the differential gear of FIG. 1;

FIG. 4 is a schematic plan view showing a transverse-mounted front-engine, front-drive, four-wheel-drive vehicle having the differential gear of FIG. 1;

FIG. 5 is a sectional view showing a differential gear according to a second embodiment of the present invention;

FIG. 6 is a sectional view showing a differential gear according to a third embodiment of the present invention;

FIG. 7 is a sectional view showing a differential gear according to a fourth embodiment of the present invention;

FIG. 8 is a schematic sectional view showing a differential gear according to a fifth embodiment of the present invention; and

FIG. 9 is a schematic sectional view showing a differential gear according to a sixth embodiment of the present invention;

### DETAILED DESCRIPTION OF EMBODIMENTS

The compactness of a differential gear having first and second differential mechanisms in radial and axial directions is achieved by face gears included in at least one of the first and second differential mechanisms.

### First Embodiment

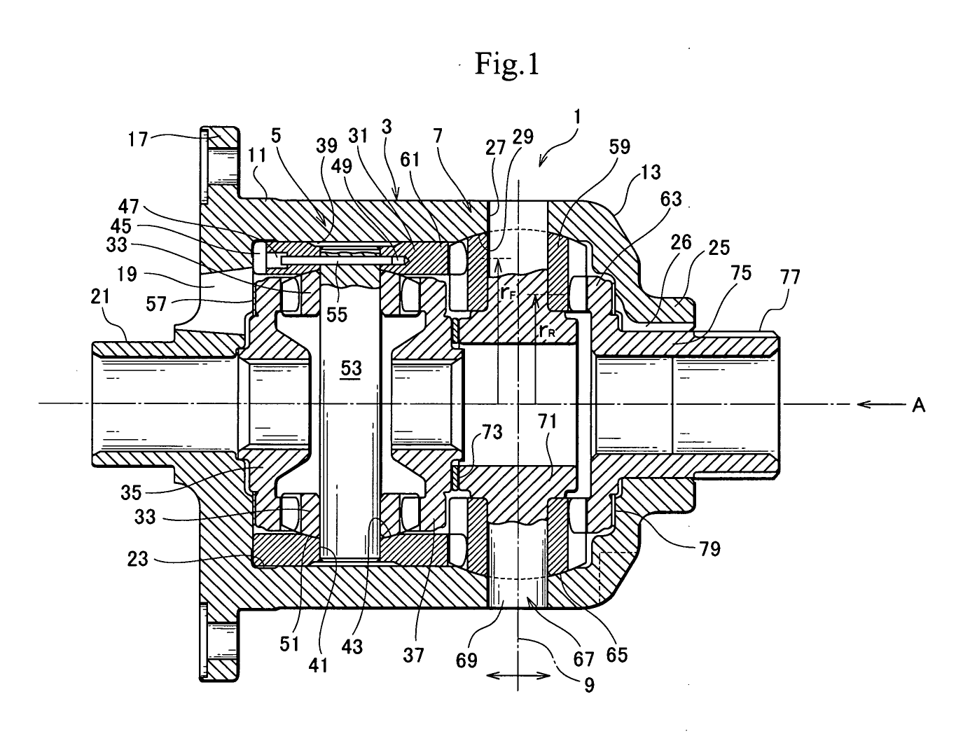

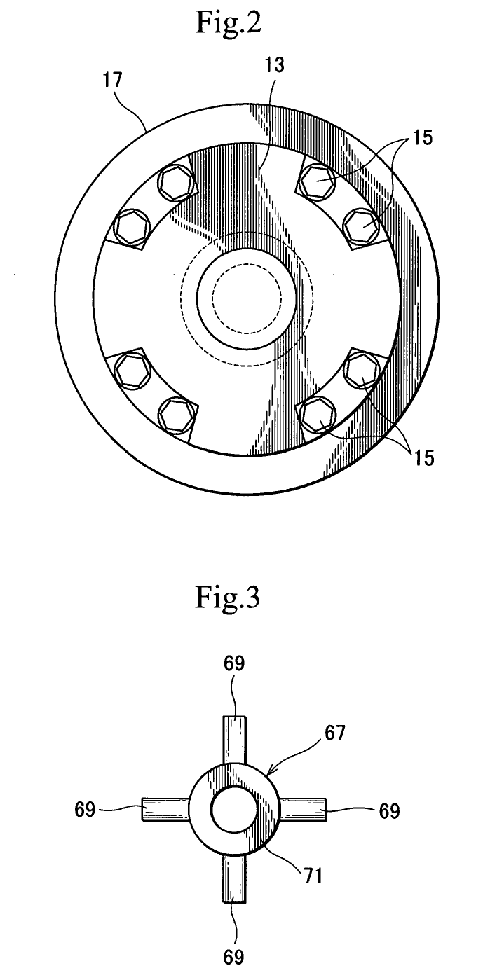

A differential gear according to the first embodiment of the present invention will be explained with reference to FIGS. 1 to 3. FIG. 1 is a sectional view showing a differential gear according to the first embodiment of the present invention, FIG. 2 is a side view seen from an arrow A shown in FIG. 1, and FIG. 3 is a side view showing a pinion shaft in the differential gear of FIG. 1.

The differential gear of FIG. 1 is used as, for example, a front differential and center differential of a four-wheel-drive vehicle and includes a center casing 3 corresponding to an external rotary member. The center casing 3 contains a first differential mechanism 5 and a second differential mechanism 7 that are arranged side by side.

The center casing 3 is rotatably supported with a differential carrier and receives torque as rotary input from a transmission via a ring gear. The center casing 3 is divided along a division line 9 into a body 11 and a lid 13. The body 11 and lid 13 are fixed to each other at circumferential four locations each with two bolts 15 as shown in FIG. 2 that is a view seen from an arrow A of FIG. 1.

The body 11 includes a flange 17, an opening 19, a boss 21, and a circumferential recess 23. The lid 13 includes a boss 25 and an oil passage 26. Between the body 11 and the lid 13, there are four shaft support holes 27 formed at circumferential four locations. The center axis of each shaft support hole 27 extends in a diametral direction of the body 11 and lid 13. At each shaft support hole 27, the body 11 and lid 13 each have a spherical pinion support recess 29.

The flange 17 is to attach the ring gear thereto. The opening 19 is to introduce lubricant. The bosses 21 and 25 each receive a bearing that rotatably supports the center casing 3 with respect to the carrier. The oil passage 26 as a groove runs along inner faces of the lid 13 and boss 25, to guide lubricant into the center casing 3.

In the center casing 3, the first and second differential mechanisms 5 and 7 are juxtaposed in the direction of an axis of rotation. The first differential mechanism 5 serves as a front differential and the second differential mechanism 7 as a center differential.

The first differential mechanism 5 includes a front casing 31 corresponding to an internal rotary member, a pair of first pinion gears 33 corresponding to first input gears, and a pair of side gears 35 and 37 corresponding to first output gears.

The front casing 31 has a ring shape. An outer circumferential face of the front casing 31 is slidably supported with an inner circumferential face of the center casing 3. The outer circumferential face of the front casing 31 has an annular recess 39. The outer circumferential face of the front casing 31 on each side of the annular recess 39 is a sliding portion that slides on the inner circumferential face of the center casing 3. The front casing 31 has a pair of shaft support holes 41. At each shaft support hole 41, an inner circumferential face of the front casing 31 has a spherical pinion support recess 43.

An end face of the front casing 31 has a cut 45. An inner part as the back of the cut 45 has a hole 47 and a pin support hole 49.

Each of the first pinion gears 33 is a spur gear, has a spherical convex face 51 on one side, and is rotatably supported with the first pinion shaft 53. The convex face 51 is fitted to the pinion support recess 43 of the front casing 31. The first pinion shaft 53 is fitted to the shaft support holes 41. The first pinion shaft 53 is prevented from dropping and turning with a spring pin 55 inserted into the pin support hole 49 and passing through the first pinion shaft 53.

In this way, the first pinion gears 33 are rotatably supported in the front casing 31.

The side gears 35 and 37 are face gears and mesh with the first pinion gears 33. Between the side gear 35 and the center casing 3, there is a thrust washer 57. The side gears 35 and 37 are coupled to axles of left and right front wheels.

The second differential mechanism 7 includes second pinion gears 59 corresponding to second input gears and second output gears 61 and 63.

Each of the second pinion gears 59 is a spur gear, has a spherical convex face 65 on one side, and is rotatably supported with an arm 69 of a second pinion shaft 67. The convex face 65 is fitted to the pinion support recess 29 of the center casing 3. As shown in FIG. 3 that is a side view, the second pinion shaft 67 is a solid four-pinion shaft having a boss 71 from which the four arms 69 extend. Each arm 69 supports one second pinion gear 59 and is fixed to the shaft support hole 27.

The second pinion gears 59 are rotatable around an axis that is orthogonal to the axis of rotation of the center casing 3.

Between the boss 71 and the side gear 37, there is a thrust washer 73.

The second output gears 61 and 63 are face gears and mesh with the second pinion gears 59 from opposite sides on the axis of rotation of the center casing 3. The second output gears 61 and 63 mesh with the second pinion gears 59 at different radial positions rF and rR as shown in FIG. 1. Namely, the meshing portion rF is shifted with respect to the meshing portion rR in a rotational radius direction of the center casing 3. Then, the meshing positions rF and rR have a relationship of rF>rR so that torque to front wheels becomes larger than torque to rear wheels.

The second output gear 61 is integral with the front casing 31 to transmit torque from the second output gear 61 to the front casing 31.

The second output gear 63 has a shaft 75 that passes through the boss 25 of the center casing 3. Outside the center casing 3, the shaft 75 has a rear output part 77 that may be made of teeth or splines. Between the second output gear 63 and the center casing 3, there is a thrust washer 79.

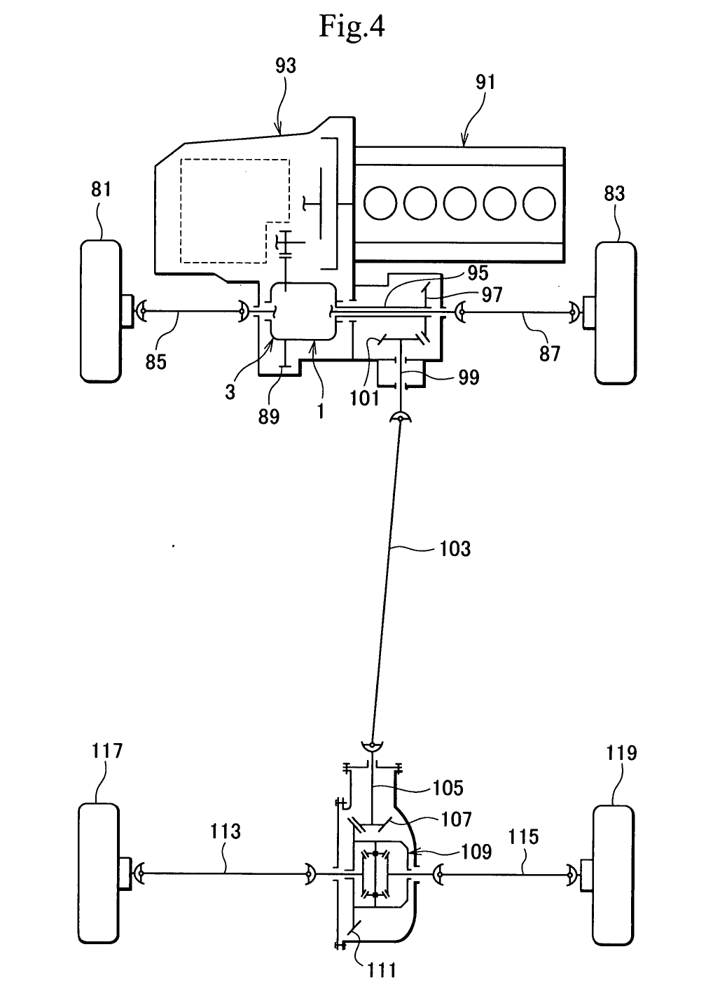

An arrangement of the differential gear 1 to a vehicle will be explained with reference to FIG. 4. FIG. 4 is a schematic plan view showing a transverse-mounted front-engine, front-drive, four-wheel-drive vehicle in which the differential gear 1 of FIG. 1 is installed.

In FIG. 4, the differential gear 1 is a torque transmission apparatus arranged between front wheels 81 and 83 coaxially with axles 85 and 87.

A ring gear 89 attached to the differential gear 1 receives torque from an engine 91 via a transmission 93. In the first differential mechanism 5 of the differential gear 1, the side gears 35 and 37 are connected to the left and right front wheels 81 and 83 through the left and right axles 85 and 87. The first differential mechanism 5 works as a front differential.

In the second differential mechanism 7, the rear output part 77 is coupled to one end of a hollow transmission shaft 95. The other end of the transmission shaft 95 has a bevel gear 97 that meshes with a bevel gear 101 attached to a rear output shaft 99. The second differential mechanism 7 works as a center differential.

The output shaft 99 is connected to a propeller shaft 103 that is connected to a drive pinion shaft 105 having a drive pinion gear 107. The drive pinion gear 107 meshes with a ring gear 111 of a rear differential gear 109 that is connected to and interlocked with left and right rear wheels 117 and 119 through left and right axles 113 and 115.

Torque transmission of the vehicle in which the differential gear 1 of FIG. 1 is installed will be explained.

Torque as output of the engine 91 is transmitted through the transmission 93 and ring gear 89 to the center casing 3 of the differential gear 1. From the center casing 3, torque is transmitted to the second pinion gears 59. From the second pinion gears 59, torque is distributed and transferred through the second output gear 61 to the front casing 31 on one side, and through the second output gear 63 and the rear output part 77 to the transmission shaft 95 on the other side.

From the front casing 31, torque is transmitted through the first pinion shaft 53 and first pinion gears 33 to the side gears 35 and 37. Thereafter, torque is transmitted through the left and right axles 85 and 87 to the left and right front wheels 81 and 83.

From the transmission shaft 95, torque is transmitted through the bevel gears 97 and 101, output shaft 99, propeller shaft 103, drive pinion shaft 105, drive pinion gear 107, and ring gear 111 to the rear differential gear 109. From the rear differential gear 109, torque is transmitted through the left and right axles 113 and 115 to the left and right rear wheels 117 and 119.

According to this embodiment, the front to rear meshing radius ratio rF:rR in the second differential mechanism 7 is set so that larger torque is distributed to the front wheels 81 and 83 than to the rear wheels 117 and 119, to stabilize the driving of the four-wheel-drive vehicle.

If differential rotation occurs between the front wheels 81 and 83 and the rear wheels 117 and 119, the second output gears 61 and 63 that transmit torque to the front and rear wheels 81, 83, 117, and 119 differentially turn due to rotation of the second pinion gears 59, thereby allowing the differential rotation between the front wheels 81 and 83 and the rear wheels 117 and 119.

During the differential rotation, thrust caused by the meshing of the second pinion gears 59 and the second output gears 61 and 63 is transferred through the thrust washer 79 to the center casing 3, through the front casing 31 to the center casing 3, and through the front casing 31, first pinion shaft 53, first pinion gears 33, side gear 35, and thrust washer 57 to the center casing 3, to thereby produce frictional force to limit the differential rotation.

When the front wheels 81 and 83 cause differential rotation, the left and right side gears 35 and 37 differentially rotate due to rotation of the first pinion gears 33, thereby allowing the differential rotation of the left and right front wheels 81 and 83.

At this time, thrust created by the meshing of the first pinion gears 33 and the side gears 35 and 37 is transferred through the thrust washer 57 to the center casing 3 and through the side gear 37 and thrust washer 73 to the second pinion shaft 67, to generate force for limiting the differential rotation.

Lubricant is introduced through the oil passage 26 and opening 19 into the center casing 3, to lubricate the first and second differential mechanisms 5 and 7.

Effect of the first embodiment will be explained. According to the first embodiment, the differential gear 1 includes the rotatably supported center casing 3 and the first and second differential mechanisms 5 and 7 that are arranged side by side along an axis of rotation in the center casing 3. The first differential mechanism 5 includes the front casing 31 rotatably supported in the center casing 3, the first pinion gears 33 rotatably supported with the first pinion shaft 53 in the front casing 31, and the pair of side gears 35 and 37 meshing with the first pinion gears 33. The second differential mechanism 7 includes the second pinion gears 59 rotatably supported with the second pinion shaft 67 in the center casing 3 and the pair of second output gears 61 and 63 meshing with the second pinion gears 59. The second pinion gears 59 of the second differential mechanism 7 are rotatably supported with the second pinion shaft 67 in the center casing 3, and the second output gear 61 is configured to transmit torque to the front casing 31. At least the first and second differential mechanisms 5 and 7 include face gears, so that the differential gear 1 with the first and second differential mechanisms 5 and 7 is compact in radial and axial directions.

Namely, the differential gear 1 is compact in a radial direction because the first and second differential mechanisms 5 and 7 are arranged side by side in an axial direction. The differential gear 1 is compact in an axial direction because the side gears 35 and 37 of the first differential mechanism 5 and the second output gears 61 and 63 of the second differential mechanism 7 are face gears meshing in the axial direction. With this configuration, the first and second differential mechanisms 5 and 7 can easily be installed in an axial direction within the center casing 3, to make the differential gear 1 compact in radial and axial directions.

Since the differential gear 1 is axially compact, a distance between constant-velocity joints of the axles 85 and 87 can sufficiently be long to reduce the fitting angles of the axles 85 and 87 and improve the noise/vibration control ability of the differential gear 1. Additionally, the differential gear 1 is prevented from increasing the radial size, so that it is advantageous in securing a minimum ground clearance for the vehicle.

### Second Embodiment

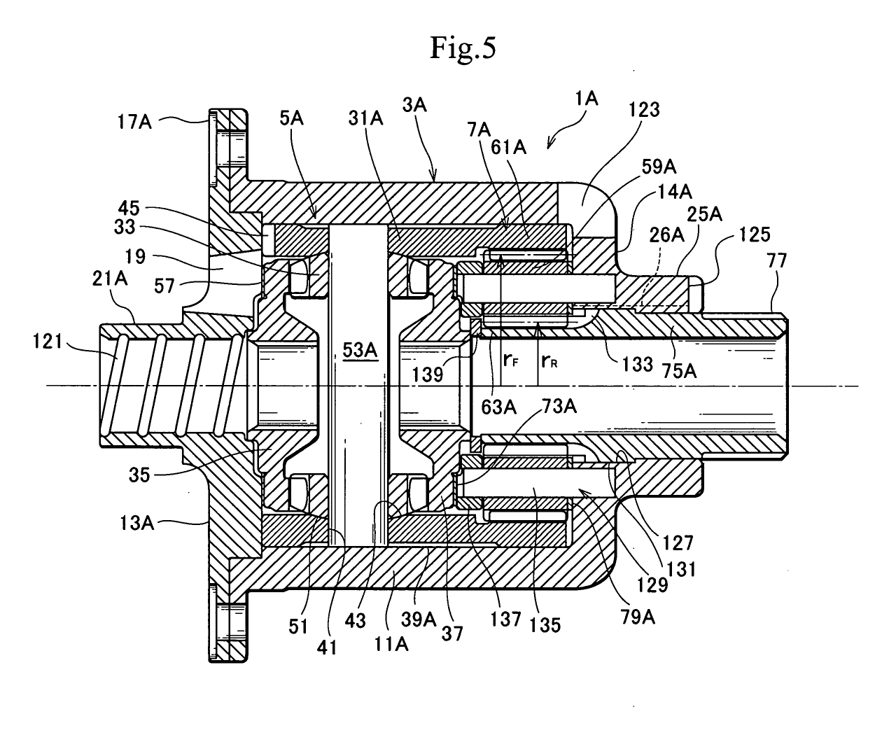

A differential gear according to the second embodiment of the present invention will be explained with reference to FIG. 5. FIG. 5 is a sectional view showing a differential gear according to the second embodiment of the present invention. The second embodiment is basically the same as the first embodiment, and therefore, the same or like parts are represented with the same reference numerals or the same reference numerals plus “A.”

The differential gear 1A according to the second embodiment is characterized by a modified second differential mechanism 7A.

The second differential mechanism 7A includes second pinion gears 59A corresponding to second input gears supported around axis along the axis of rotation of a center casing 3A. A pair of second output gears 61A and 63A meshes with the second pinion gears 59A from each side of the second pinion gears 59A in a radial direction.

The center casing 3A is divided at a flange 17A into a body 11A and a lid 13A. The body 11A, the lid 13A, and a ring gear are fixed together at the flange 17A by a bolt. The center casing 3A has a boss 21A whose inner circumferential face has a spiral oil passage 121 as a spiral groove. The center casing 3A has an opening 123 and a cut 125 in the side of the second differential mechanism 7A. The center casing 3A has a boss 25A whose inner circumferential face has a circumferential stop recess 127 to engage in the axial direction.

The first differential mechanism 5A has a first pinion shaft 53A. Each end of the first pinion shaft 53A has a curved end face whose curvature corresponds to an inner circumferential face of the center casing 3A. The first pinion shaft 53A is slidable along the inner circumferential face of the center casing 3A, to prevent the first pinion shaft 53A from dropping in an axial direction.

The second differential mechanism 7A employs, for example, a planetary gear mechanism with helical gears and includes the second pinion gears 59A serving as planetary gears, the second output gear 61A serving as an internal gear, and the second output gear 63A serving as a sun gear. The second pinion gears 59A are rotatably supported with a carrier 129. The second output gear 63A has a gear shaft 75A provided with a circumferential projection 131 that engages with the stop recess 127 of the center casing 3A.

The gear shaft 75A has a recess 133 whose one end communicates with teeth of the second output gear 63A and whose the other end communicates with an oil passage 26A of the center casing 3A.

The second output gears 61A and 63A have a meshing radius ratio rF:rR with respect to the second pinion gears 59A. According to the second embodiment, the ratio rF:rR has a relationship of rF>rR so that torque distributed to front wheels becomes larger than torque distributed to rear wheels.

The carrier 129 includes a side wall 14A of the center casing 3A, carrier pins 135 and a carrier plate 137. The carrier plate 137 is connected to the side wall 14A of the center casing 3A through bridges (not shown) and is fixed to the center casing 3A with bolts inserted from the carrier plate 137 and passed through intervals between the second pinion gears 59A. The carrier pins 135 are fitted to the center casing 3A. Between the carrier plate 137 and a side gear 37 of the first differential mechanism 5A, there is a thrust washer 73A. Between the side gear 37 and the second output gear 63A, there is a spacer 139. Between the second pinion gears 59A and the center casing 3A, there is a thrust washer 79A.

According to the second embodiment, a carrier including extending walls may be employed instead of the carrier 129 including the carrier pins 135. Each extending wall, in the center casing 3A, extends from the side wall 14A in the axial direction so as to hold the second pinion gear 59A meshing with the second output gears 61A and 63A. The extending wall may have inner circumferential face on which each tooth top of the second pinion gear 59A slides. In this case, the differential gear generates large limiting force of differential rotation by friction due to sliding each tooth top of the second pinion gear 59A on the inner circumferential face of the extending wall.

Torque transmitted to the center casing 3A is transferred to the second pinion gears 59A. From the second pinion gears 59A, torque is distributed and transferred through the second output gear 61A to a front casing 31A on one side, and through the second output gear 63A and the rear output part 77 to a rear side on the other side.

If differential rotation occurs, thrust between the second pinion gears 59A and the second output gears 61A and 63A is transferred through the thrust washer 79A to the center casing 3A, through the front casing 31A to the center casing 3A, and through the front casing 31A, first pinion shaft 53A, first pinion gears 33, side gear 35, and thrust washer 57 to the center casing 3A, to generate force for limiting the differential rotation.

On the first differential mechanism 5A side, lubricant is introduced through the oil passage 121 and opening 19. On the second differential mechanism 7A side, lubricant is introduced through the cut 125 to the oil passage 26A to the first pinion gears 59A. Lubricant is also introduced through the oil passage 26A and recess 133 to the second output gear 63A. From the opening 123, lubricant is passed to the second output gear 61A. In this way, lubricant is supplied into the center casing 3A, to sufficiently lubricate the first and second differential mechanisms 5A and 7A.

### Third Embodiment

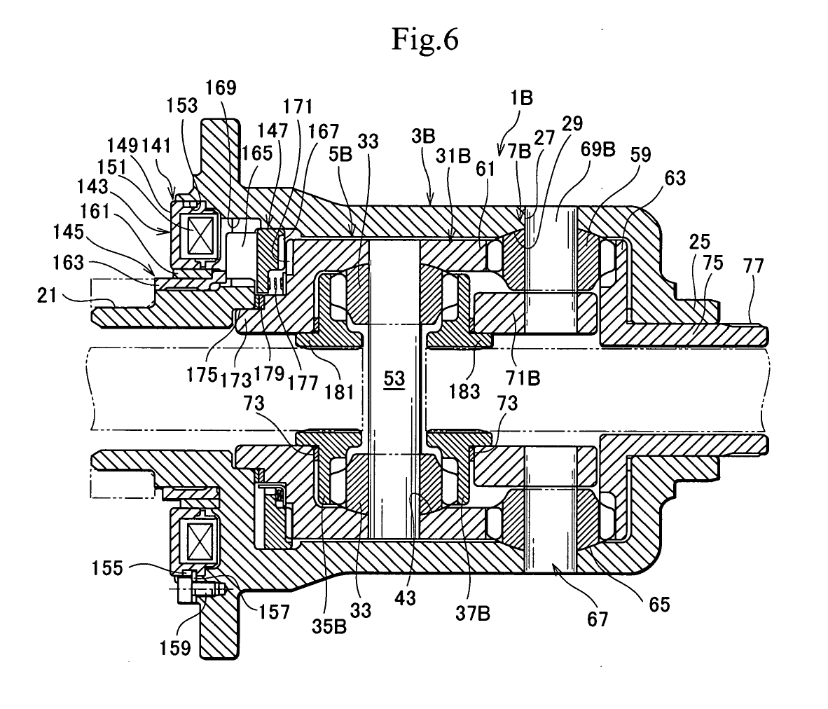

A differential gear according to the third embodiment of the present invention will be explained with reference to FIG. 6. FIG. 6 is a sectional view showing a differential gear according to the third embodiment of the present invention. The third embodiment is basically the same as the first embodiment, and therefore, the same or like parts are represented with the same reference numerals or the same reference numerals plus “B.”

The differential gear 1B according to the third embodiment is characterized by a modified second differential mechanism 7B as a center differential provided with a lock-up mechanism 141 that locks up the second differential mechanism 7B.

The lock-up mechanism 141 includes an electromagnet or a solenoid 143, a plunger 145, and a lock 147.

The solenoid 143 is connected through a harness to a controller. The solenoid 143 generates electromagnetic force in response to a control current and includes a housing yoke 149 and a coil 151.

The yoke 149 is made of a magnetic material, has an annular shape, and is concentric with respect to the axis of rotation of the differential gear 1B. The yoke 149 can rotate relative to a center casing 3B and is positioned in diametral and axial directions. An outer circumference of the yoke 149 is rotatably fitted to a yoke recess 153 of the center casing 3B. With this, the yoke 149 is positioned in the diametral direction. The outer circumference of the yoke 149 has a circumferential recess 155 to receive a positioning plate 157 of the center casing 3B. The positioning plate 157 is fixed to an end face of the center casing 3B with bolts 159, to position the yoke 149 in the axial direction.

The plunger 145 has an annular shape and includes a magnetic member 161 and a nonmagnetic member 163 that works in cooperation with the magnetic member 161. The nonmagnetic member 163 is fixed to the magnetic member 161 to be integrated with the magnetic member 161 by welding, heat-treatment, and the like.

The lock 147 has a ring shape and is arranged in the center casing 3B on one side of a first differential mechanism 5B. The lock 147 has a projection 165 on one side face and a clutch 167 defined by a tooth on the other side face.

The projection 165 protrudes through a hole 169 of the center casing 3B toward the plunger 145 and abuts against the nonmagnetic member 163. The clutch 167 is arranged to face and engage with a clutch 171 defined by a tooth of the first differential mechanism 5B. The clutch 171 is arranged on one end face of a front casing 31B. The front casing 31B has a fitting part 173 fitted to a recess 175 of the center casing 3B. Between the front casing 31B and the nonmagnetic part 163, there is a return spring 177. Between the front casing 31B and the center casing 3B, there is a thrust washer 179.

Side gears 35B and 37B have gear fitting parts 181 and 183, respectively. The gear fitting part 181 is fitted to the front casing 31B and the gear fitting part 183 is fitted to an annular shaft boss 71B. The shaft boss 71B is independent of a shaft 69B. The shaft 69B is fitted to the shaft boss 71B.

When no current is supplied to the solenoid 143, the lock 147 is pushed by the return spring 177 so that the clutches 167 and 171 are disengaged from each other to put the differential gear 1B in an unlocked state. In this state, the differential gear 1B transmits torque like the first embodiment.

When a control current is supplied to the solenoid 143, magnetic flux is formed through the yoke 149 and the magnetic part 161 of the plunger 145, to move the plunger 145. As a result, the lock 147 moves against the force of the return spring 177, to engage the clutches 167 and 171 with each other. Namely, the lock 147 engages the front casing 31B with the center casing 3B. This makes second pinion gears 59 of the second differential mechanism 7B unable to rotate, to thereby lock up the second differential mechanism 7B.

In the differential gear 1B under the locked-up state, the first differential mechanism 5B allows differential rotation between front wheels 81 and 83 during torque transmission. At this time, a second output gear 63 of the second differential mechanism 7B rotates together with the center casing 3B to transmit torque to rear wheels 117 and 119.

In this way, the third embodiment can provide the same effect as the first embodiment, and in addition, can easily arrange the lock-up mechanism 141 in an axial direction.

### Fourth Embodiment

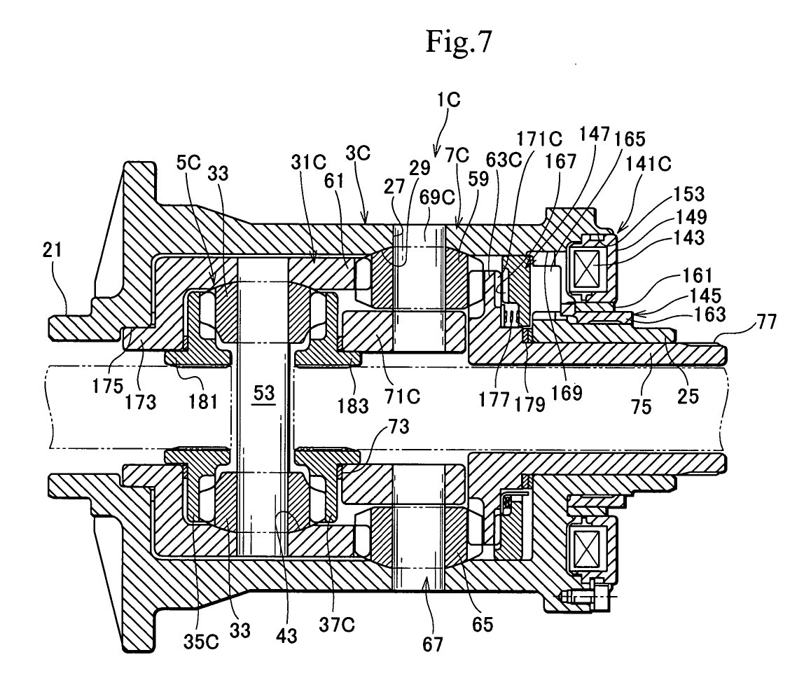

A differential gear according to the fourth embodiment of the present invention will be explained with reference to FIG. 7. FIG. 7 is a sectional view showing a differential gear according to the fourth embodiment of the present invention. The fourth embodiment is basically the same as the third embodiment, and therefore, the same or like parts are represented with the same reference numerals or the same reference numerals plus “C” instead of “B.”

The differential gear IC is characterized by a lock-up mechanism 141C for locking up a second differential mechanism 7C.

The lock-up mechanism 141C is arranged adjacent to the second differential mechanism 7C. Due to this, a clutch 171C is formed on the back face of a second output gear 63C of the second differential mechanism 7C.

According to the fourth embodiment, the lock-up mechanism 141C operates to make the second output gear 63C unable to rotate relative to a center casing 3C, thereby locking up the second differential mechanism 7C.

The fourth embodiment provides the same effect as the third embodiment.

### Fifth Embodiment

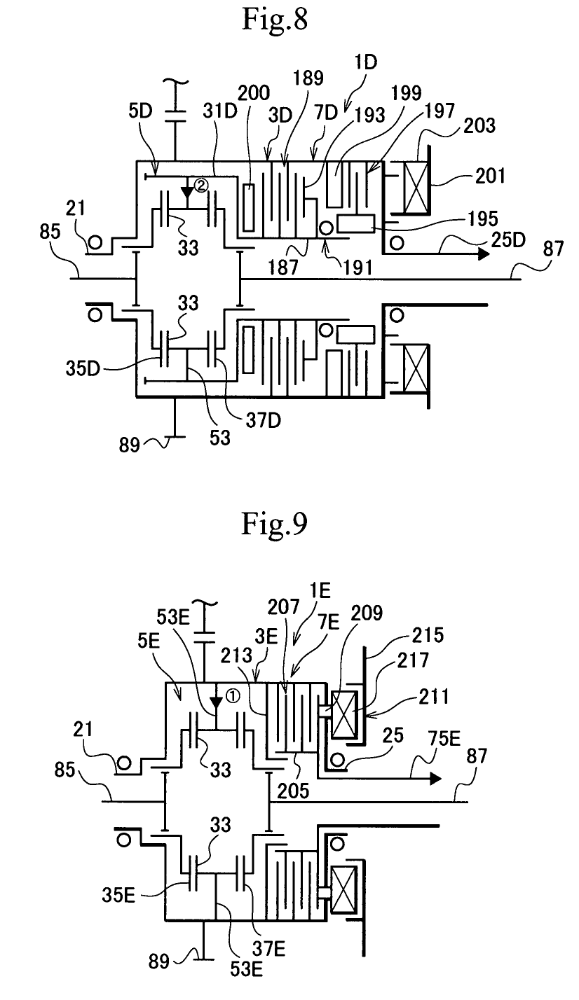

A differential gear according to the fifth embodiment of the present invention will be explained with reference to FIG. 8. FIG. 8 is a schematic sectional view showing a differential gear according to the fifth embodiment of the present invention. The fifth embodiment is basically the same as the first embodiment, and therefore, the same or like parts are represented with the same reference numerals or the same reference numerals plus “D.”

The differential gear ID according to the fifth embodiment includes a first differential mechanism 5D and a second differential mechanism 7D and is characterized in that one of the first and second differential mechanisms (in this embodiment, the second differential mechanism 7D) is formed to receive torque due to the rotation of a center casing 3D and transmit the torque to the other of the first and second differential mechanisms (in this embodiment, the first differential mechanism 5D) and in that the one differential mechanism (the second differential mechanism 7D) includes a multi-disk clutch controlled by an actuator. According to this embodiment, the multi-disk clutch is an electromagnetic clutch.

The second differential mechanism 7D includes the center casing 3D, a clutch hub 187, a main clutch 189 which is a multi-disk clutch, a ball cam 191, a pressure ring 193, a cam ring 195, a multi-disk pilot clutch 197, an armature 199, a pressure receiving ring 200, and an electromagnet 201.

The clutch hub 187 is rotatably supported by the center casing 3D. One end of the clutch hub 187 is connected to a front casing 31D.

The main clutch 189 is arranged between the center casing 3D and the clutch hub 187. Each outer plate of the main clutch 189 engages through splines with an inner circumference of the center casing 3D. Each inner plate of the main clutch 189 engages through splines with an outer circumference of the clutch hub 187.

The pilot clutch 197 is arranged between the center casing 3D and the cam ring 195. Each outer plate of the pilot clutch 197 engages through splines with the inner circumference of the center casing 3D. Each inner plate of the pilot clutch 197 engages through splines with an outer circumference of the cam ring 195.

The ball cam 191 is formed between the pressure ring 193 and the cam ring 195. The pressure ring 193 engages through splines with the outer circumference of the clutch hub 187, is axially movable, and receives thrust from the ball cam 191 to push the main clutch 189.

Between the cam ring 195 and the center casing 3D, there is a thrust bearing that receives reactive force from the ball cam 191 for the center casing 3D and allows relative rotation between the cam ring 195 and the center casing 3D.

Between the pressure ring 193 and the clutch hub 187, there is a return spring that pushes the pressure ring 193 in a direction to disengage the main clutch 189.

The armature 199 and pressure receiving ring 200 each have an annular shape. The armature 199 is arranged between the pressure ring 193 and the pilot clutch 197, and the pressure receiving ring 200 is arranged between the front casing 31D and the main clutch 189.

Between a core 203 of the electromagnet 201 and the center casing 3D, there is a proper air gap in a diametral direction. A side wall of the center casing 3D has a nonmagnetic part. This arrangement forms a magnetic path from the electromagnet 201 to the center casing 3D, pilot clutch 197, and armature 199, to form a magnetic flux loop.

When the electromagnet 201 is magnetized, the magnetic flux loop attracts the armature 199 to engage the pilot clutch 197 with respect to the center casing 3D, thereby generating pilot torque. The pilot torque is transferred through the cam ring 195 connected to the center casing 3D via the pilot clutch 197, and thereby, transferring torque acts on the ball cam 191 between the cam ring 195 and the pressure ring 193 of the clutch hub 187. The ball cam 191 amplifies the transferring torque and converts the same into thrust to move the pressure ring 193 to engage the main clutch 189.

Consequently, the second differential mechanism 7D is engaged. Then, torque of the center casing 3D is transferred to the clutch hub 187 and to the first differential mechanism 5D. The torque of the first differential mechanism 5D is transmitted to front wheels 81 and 83. On the other hand, to rear wheels 117 and 119, the torque of the center casing 3D is always transmitted through a shaft 25D.

If differential rotation occurs between the front wheels 81 and 83 and the rear wheels 117 and 119, the main clutch 189 slips to absorb the differential rotation. The slippage of the main clutch 189 can be controlled by detecting differential rotation and by controlling a current to the electromagnet 201 with the use of a computer according to the detected differential rotation.

The main clutch 189 may strongly be engaged to lock up the second differential mechanism 7D.

When the electromagnet 201 is deactivated, the pilot clutch 197 is released to vanish the thrust of the ball cam 191. Then, the pressure ring 193 returns to an original position due to the return spring, to disengage the main clutch 189. This releases the engaged state of the second differential mechanism 7D, to transmit no torque to the front wheels 81 and 83.

In this way, the fifth embodiment can provide the same effect as the above-mentioned embodiments.

The fifth embodiment can easily arrange the second differential mechanism 7D with the lock-up mechanism in an axial direction. The fifth embodiment can share the differential mechanism 7D with the lock-up mechanism.

### Sixth Embodiment

A differential gear according to the sixth embodiment of the present invention will be explained with reference to FIG. 9. FIG. 9 is a schematic sectional view showing a differential gear according to the sixth embodiment of the present invention. The sixth embodiment is basically the same as the first embodiment, and therefore, the same or like parts are represented with the same reference numerals or the same reference numerals plus “E.”

The differential gear 1E according to the sixth embodiment is characterized in that torque due to the rotation of a center casing 3E is transferred to first and second differential mechanisms 5E and 7E in parallel and in that one of the first and second differential mechanisms 5E and 7E (in this embodiment, the second differential mechanism 7E) employs a multi-disk clutch controlled by an actuator. According to this embodiment, the multi-disk clutch is a hydraulic clutch.

The second differential mechanism 7E includes the center casing 3E, a clutch hub 205, the multi-disk clutch 207, a pressure part 209, and a hydraulic actuator 211.

The clutch hub 205 is integral with a rear output shaft 75E. The center casing 3E has a pressure receiving plate 213.

The hydraulic actuator 211 is supported by a housing 215 as a fixed lateral, and a hydraulic piston 217 pushes the pressure part 209 in response to a hydraulic pressure.

The first differential mechanism 5E includes a side gear 37E that is supported with an inner circumference of the pressure receiving plate 213.

When a control pressure is applied to the hydraulic actuator 211, the hydraulic piston 217 presses the pressure part 209 to engage the multi-disk clutch 207 with the pressure receiving plate 213.

Torque of the center casing 3E is transmitted to the first differential mechanism 5E to front wheels 81 and 83. At the same time, the torque of the center casing 3E is transmitted to the second differential mechanism 7E, and due to the engagement of the multi-disk clutch 207, to the clutch hub 205 to the rear output shaft 75E to rear wheels 117 and 119.

If differential rotation occurs between the front wheels 81 and 83 and the rear wheels 117 and 119, the multi-disk clutch 207 slips to absorb the differential rotation. The slippage of the multi-disk 207 is controllable by detecting differential rotation and by controlling a hydraulic pressure applied to the hydraulic actuator 211 with the use of a computer according to the detected differential rotation.

The multi-disk clutch 207 may strongly be engaged to lock up the second differential mechanism 7E.

When the hydraulic pressure to the hydraulic actuator 211 is released, the multi-disk clutch 207 is disengaged to release the second differential mechanism 7E. Then, no torque is transmitted to the rear wheels 117 and 119.

In this way, the sixth embodiment can provide the same effect as the above-mentioned embodiments.

The sixth embodiment can easily arrange the second differential mechanism 7E with the lock-up mechanism in an axial direction. The sixth embodiment can share the differential mechanism 7E with the lock-up mechanism.

As mentioned above, the object of the present invention is to provide a differential gear having first and second differential mechanisms that are compact in radial and axial directions. In the fifth and sixth embodiments, the important factor to achieve the object is to apply the clutch mechanism to one of the first and second differential mechanisms.

Therefore, according to the fifth and sixth embodiments, a differential gear set including a pinion gear and a pair of output gears may be applied to one of first and second differential mechanisms and a clutch mechanism (referred to as on-demand coupling mechanism for example) may be applied to the other of the first and second differential mechanisms, and the differential gear set may include, for example, bevel gears, planetary gears or the like instead of face gears. This is an equivalent technique according to the fifth and sixth embodiments, and therefore, it is possible to provide a differential gear that is lightweight and compact and has good running stability.

According to above embodiments, the first pinion gears 33 are supported to the front casing 31 (including 31A to 31D) through the first pinion shaft 53 (including 53A and 53E) and the second pinion gears 59 (including 59A) are supported to the center casing 3 (including 3A to 3E) through the second pinion shaft 67. The first and second pinion shafts 53 and 67 may be omitted. In this case, openings may be formed on a front casing and center casing, to directly support the first and second pinion gears 53 and 59 to the front casing and the center casing with the openings. In this way, if the pinion shafts are omitted, it has effect to simplify the structure, improve the degree of freedom in shape design of the first and second pinion gears and generate limiting force of differential rotation of the differential gear by friction due to sliding each tooth top or outer surface of the first and second pinion gears on the inner circumferential face of the openings.

Further, according to above embodiments, in view of a space in which a differential gear is installed, acceptable value of transferring torque and the like, bevel gears may be applied to one of first and second differential gears and face gears may be applied to the other of the first and second differential gears.

What is claimed is:

1. A differential gear comprising:
an external rotary member configured to rotate;
first and second differential mechanisms arranged side by side along an axis of rotation in the external rotary member, the external rotary member coupled to the first and second differential mechanisms in such a way as to transmit rotation of the external rotary member to the first and second differential mechanisms in parallel; and
face gears included in at least one of the first and second differential mechanisms.

2. A differential gear comprising:
an external rotary member configured to rotate;
first and second differential mechanisms arranged side by side along an axis of rotation in the external rotary member, the external rotary member coupled to the first and second differential mechanisms in such a way as to transmit rotation of the external rotary member to one of the first and second differential mechanisms via the other of the first and second differential mechanisms; and
face gears included in at least one of the first and second differential mechanisms.

3. The differential gear of claim 1, wherein:
the first differential mechanism comprises:
internal rotary member rotatably supported in the external rotary member;
a first input gear rotatably supported by the internal rotary member; and
a pair of first output gears meshing with the first input gear;
the second differential mechanism comprises:
a second input gear rotatably supported in the external rotary member; and
a pair of second output gears meshing with the second input gear; and
one of the second output gears is configured to transmit rotation thereof to the internal rotary member.

4. The differential gear of claim 2, wherein:
the first differential mechanism comprises:
internal rotary member rotatably supported in the external rotary member;
a first input gear rotatably supported by the internal rotary member; and
a pair of first output gears meshing with the first input gear;
the second differential mechanism comprises:
a second input gear rotatably supported in the external rotary member; and
a pair of second output gears meshing with the second input gear; and
one of the second output gears is configured to transmit rotation thereof to the internal rotary member.

5. The differential gear of claim 3, wherein:
the second input gear is supported with a shaft that is orthogonal to an axis of rotation of the external rotary member; and
the second output gears are arranged on opposite sides of the second input gear along the axis of rotation of the external rotary member.

6. The differential gear of claim 4, wherein:
the second input gear is supported with a shaft that is orthogonal to an axis of rotation of the external rotary member; and
the second output gears are arranged on opposite sides of the second input gear along the axis of rotation of the external rotary member.

7. The differential gear of claim 5, wherein:
a position where one of the second output gears meshes with the second input gear differs in a rotational radius direction of the external rotary member from a position where the other of the second output gears meshes with the second input gear.

8. The differential gear of claim 6, wherein:
a position where one of the second output gears meshes with the second input gear differs in a rotational radius direction of the external rotary member from a position where the other of the second output gears meshes with the second input gear.

9. The differential gear of claim 3, wherein:
the second input gear is supported with a shaft that extends in parallel to an axis of rotation of the external rotary member; and
the second output gears are arranged on opposite sides of the second input gear in a rotational radius direction of the external rotary member.

10. The differential gear of claim 4, wherein:
the second input gear is supported with a shaft that extends in parallel to an axis of rotation of the external rotary member; and
the second output gears are arranged on opposite sides of the second input gear in a rotational radius direction of the external rotary member.

11. The differential gear of claim 1, further comprising:
a lock-up mechanism configured to lock up one of the first and second differential mechanisms.

12. The differential gear of claim 2, further comprising:
a lock-up mechanism configured to lock up one of the first and second differential mechanisms.

13. The differential gear of claim 1, wherein:
one of the first and second differential mechanisms is comprised of a multi-disk clutch controlled by an actuator.

14. The differential gear of claim 2, wherein:
said one of the first and second differential mechanisms is comprised of a multi-disk clutch controlled by an actuator.
